(19) United States
(12) Patent Application Publication
(10) Pub. No.: US 2016/0070068 A1
(43) Pub. Date: Mar. 10, 2016

(54) TOP COUPLED PHOTONIC CHIP ALIGNMENT PACKAGE

(71) Applicant: BAE SYSTEMS Information and Electronic Systems Integration Inc., Nashua, NH (US)

(72) Inventor: Andrew TS Pomerene, Leesburg, VA (US)

(21) Appl. No.: 14/845,700

(22) Filed: Sep. 4, 2015

Related U.S. Application Data
(60) Provisional application No. 62/047,281, filed on Sep. 8, 2014.

(51) Int. Cl. G02B 6/30; G02B 6/25; G02B 6/42; G02B 6/34; G02B 5/32; G02B 6/124; G02B 6/36

(52) U.S. Cl. CPC G02B 6/30; G02B 6/124; G02B 6/25; G02B 6/3636; G02B 6/3668; G02B 6/34; G02B 5/32; G02B 6/423; G02B 6/4295; G02B 6/4249; G02B 6/4286; G02B 2006/12061

(57) ABSTRACT

The present invention provides an improved coupling and improved alignment of top-coupled photonic chips. The present invention includes a method to package and align top-coupling photonic chips using a holographic grating coupler and V-groove placement comprising the steps of: preparing the photonic chip with grating couplers, preparing the fibers by polishing the ends, preparing the cap chip by defining V-grooves to complement the photonic chip, attaching the fibers to the V-block cap chip, and top-cladding the cap chip to the photonic chip. The present invention also includes the apparatus resulting from the aforementioned method.

### RELATED APPLICATIONS

This application claims the benefit of U.S. Provisional Application No. 62/047,281, filed 8 Sep. 2014. This application is herein incorporated by reference in its entirety for all purposes.

### FIELD OF THE INVENTION

The present invention relates to photonic chips. More specifically, it relates to the bonding of optical fibers to silicon photonic chips.

### BACKGROUND OF THE INVENTION

The prior art discloses a number of ways to achieve bonding of optical fibers to photonic chips.

U.S. Pat. No. 3,994,559 from IBM in 1975, for example, concerns the coupling of optical fibers to corresponding individual waveguides. It concerns use of an optical structure to achieve a leaky wave coupling from one guided mode structure to another guided mode structure. It is fabricated by planar deposition and etching techniques because it uses precise axial alignment per V-shaped grooves in the substrate for depositing the waveguides.

U.S. Pat. No. 7,889,963, concerns an optical waveguide device which is small and has high impact resistance. It has a V-shaped groove on a surface at the end of a base board where an optical waveguide section is formed. Embedded by an adhesive layer, an optical fiber element is connected to this base board by an end fitted into the V-shaped groove.

An improved way, however, is still necessary to achieve high accuracy, particularly the accuracy necessary for targeting areas less than a square micron.

### SUMMARY OF THE INVENTION

An embodiment provides a method for bonding optical fibers to a photonic chip comprising the steps of preparing the photonic chip with at least one grating coupler; preparing at least one optical fiber by polishing an end; preparing a cap chip by defining at least one V-groove; attaching the at least one optical fiber to the V-block cap chip; and top-cladding the V-block cap chip to the photonic chip. In embodiments, the fibers are polished at a 45° angle whereby the grating couplers on the photonic chip are illuminated. In other embodiments, the fiber end is metalized to reflect an optical signal down from a horizontal plane to a vertical plane; and the top cap chip is a photonic chip made of silicon. In subsequent embodiments, the at least one grating coupler vertically directs an optical signal from a surface of a die. For additional embodiments, the at least one grating coupler comprises a plurality of offset couplers. In another embodiment, the at least one optical fiber is embedded so as to align the metalized end with the grating couplers on the photonic chip. For a following embodiment, the z-axis alignment is controlled by the cladding. In subsequent embodiments, the input light from the at least one optical fiber projects onto any light detector. In additional embodiments, the photonic chip allows for simultaneous reading of many different fiber sources.

Another embodiment provides a top-coupling photonic chip device comprising a photonic chip comprising at least one grating coupler; a top cap chip comprising at least one V-groove; and at least one optical fiber embedded in the at least one V-groove, and aligned with the at least one grating coupler. In included embodiments, the at least one V-groove controls x- and y-axes alignment of the at least one optical fiber. In yet further embodiments, the top cap chip is a photonic chip made of silicon. In related embodiments, the at least one grating coupler vertically directs an optical signal from a surface of a die. For further embodiments, the at least one grating coupler comprises at least one holographic grating coupler. In ensuing embodiments, the at least one target area on the photonic chip is less than a square micron. For yet further embodiments, the at least one V-groove is etched in the silicon. For more embodiments, the at least one grating coupler comprises a plurality of offset couplers. In continued embodiments the device is an area detector. For additional embodiments, the device is a CMOS imager.

A yet further embodiment provides a system for moving optical signals to and from photonic chips comprising a photonic chip comprising a plurality of holographic grating couplers; a cap chip comprising a plurality of V-grooves; a plurality of optical fibers, each embedded in a V-groove of the plurality of V-grooves, whereby each of the plurality of holographic grating couplers is aligned with one of the plurality of optical fibers; the system inputting light from the plurality of optical fibers onto detectors of different light wavelengths; and wherein at least one target area on the photonic chip is less than a square micron, and whereby high accuracy necessary for targeting areas less than a square micron is achieved.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 shows input and output optical fibers manually attached to the side of a photonic chip.

FIG. 2 is a diagram of a photonic chip with grating couplers configured in accordance with one embodiment of the present invention.

FIG. 3 is a diagram of a cap chip with fibers attached configured in accordance with one embodiment of the present invention.

FIG. 4 is a diagram of the application of the cap chip to the photonic chip with grating couplers configured in accordance with one embodiment of the present invention.

FIG. 5 is a diagram of embodiments with offset fibers configured in accordance with one embodiment of the present invention.

FIG. 6 is an image showing receivers and fibers configured in accordance with the present invention.

FIG. 7 is a method flow chart configured in accordance with one embodiment of the present invention.

### DETAILED DESCRIPTION

The present invention provides an improved coupling and improved alignment of top-coupled photonic chips. The present invention includes a method to package and align top-coupling photonic chips using a holographic grating coupler and V-groove placement comprising the steps of preparing the photonic chip with grating couplers, preparing the fibers by polishing the ends, preparing the cap chip by defining V-grooves to complement the photonic chip, attaching the fibers to the V-block cap chip, and top-cladding the cap chip to the photonic chip. The present invention also includes the apparatus resulting from the aforementioned method.

Referring to the figures, the present invention provides an improved system to move optical signals to and from photonic chips. This invention has three parts: the photonic chip, the top cap chip, and the optical fibers. The photonic chip is equipped with a holographic grating coupler. This grating coupler vertically directs the optical from the surface of the die. In the disclosed embodiment, this piece is made of silicon.

In the disclosed embodiment, the top cap chip is a photonic chip made of silicon. This chip has V-grooves etched in it which allow for the embedding of the optical fibers. These V-grooves control the x- and y-axes alignment. The z-axis alignment is controlled by the cladding function of this piece.

The optical fibers have a 45° end polish on the end that will illuminate the grating couplers on the photonic chip. This end is then metalized to reflect the optical down from the horizontal plane to the vertical plane. The optical fiber is embedded in the top cap chip via V-grooves etched in the silicon. The optical fibers are embedded as to align the metalized end with the grating couplers on the photonic chip.

In an additional embodiment, this invention may be used to input light from an optical fiber onto any light detector. This allows for simultaneous reading of many different fiber sources. An example of this embodiment is an area detector, such as a CMOS imager, which may have a top coupler.

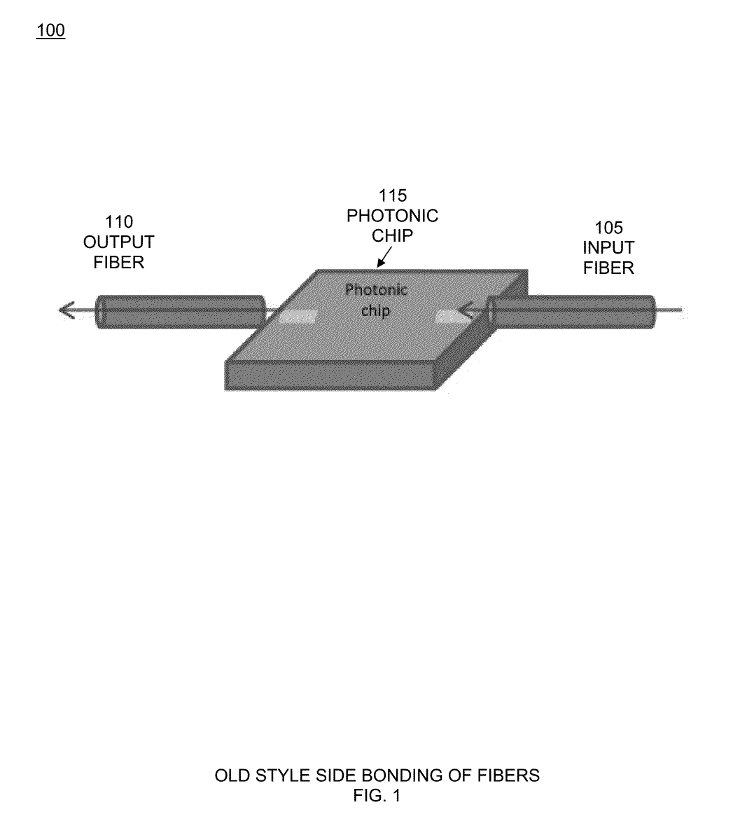

FIG. 1 shows the previous method 100 of bonding optical fibers to silicon photonic chips. In this figure, the input 105 and output 110 optical fibers are shown as manually attached to the side of photonic chip 115.

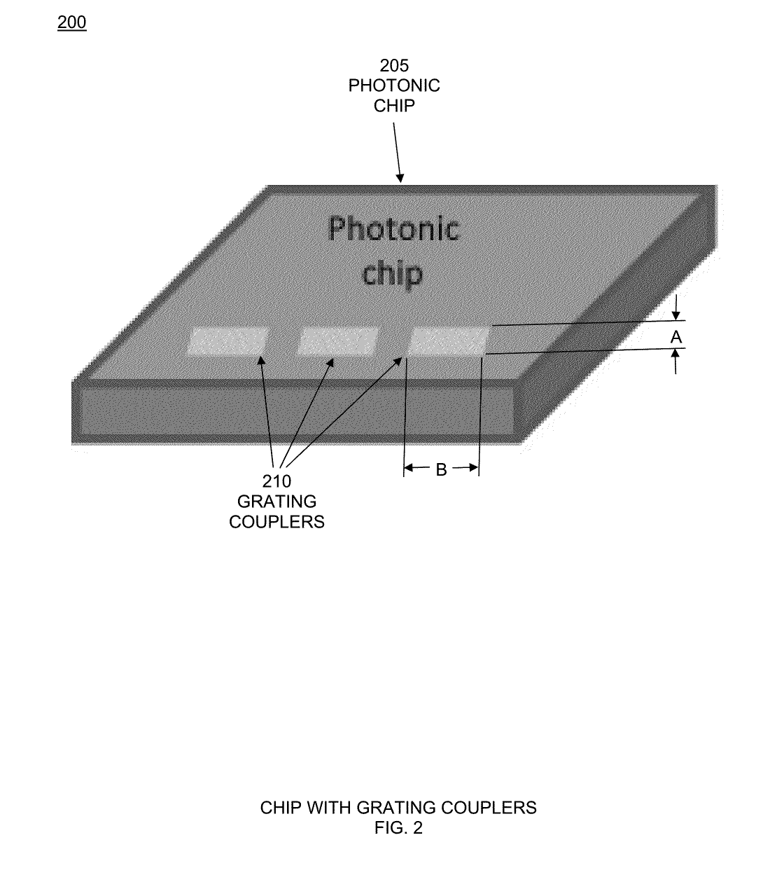

FIG. 2 is a diagram 200 of a photonic chip 205 with grating couplers. Three grating couplers 210 are shown. Each of grating dimensions A and B is less than one micron. Of particular interest is when the target areas on the photonic chip are a square micron or less, as these applications will benefit most from the high accuracy of the present invention.

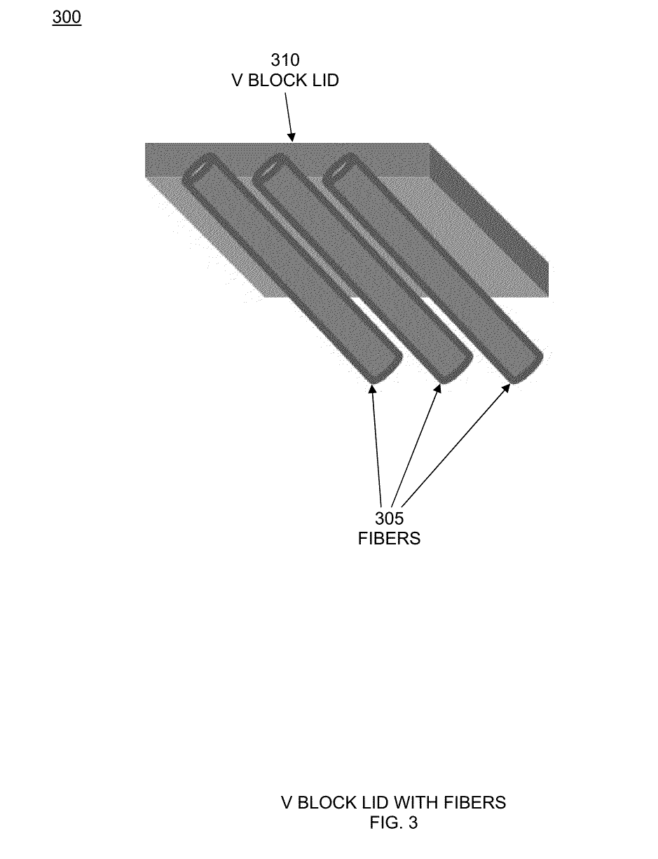

FIG. 3 is a diagram 300 of the cap chip to be bonded to the photonic chip. In this image, fibers 305 are attached to cap chip 310. It highlights the fibers which are embedded in the lid chip via V-shaped grooves etched in it.

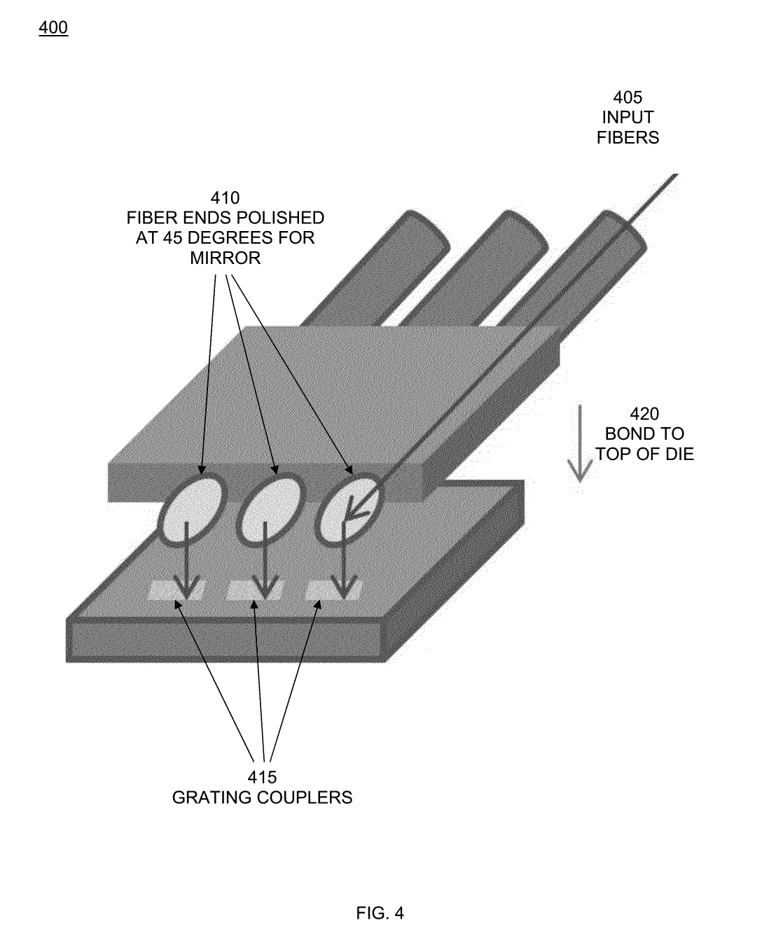

FIG. 4 is a diagram 400 of the application of the cap chip to the photonic chip with grating couplers. This figure highlights that the ends of input fibers 405 are polished at a 45° angle 410 for mirror. The polished fibers on the cap chip are aligned to the grating couplers 415 on the photonic chip for the bond to the top of the die 420.

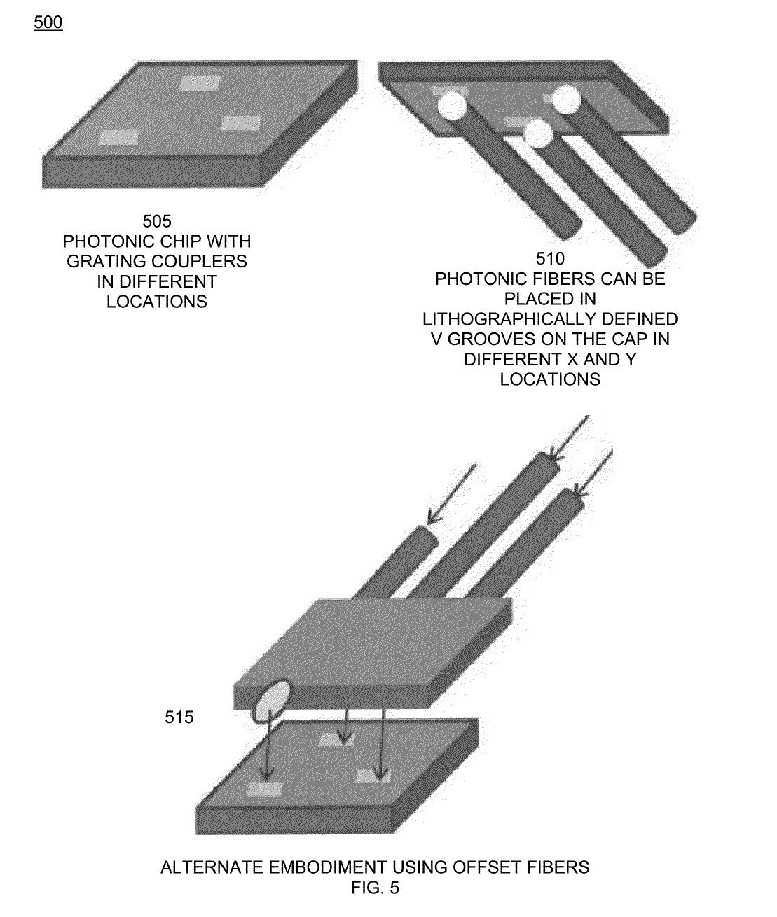

FIG. 5 is a diagram 500 of the present invention with offset fibers. A photonic chip is depicted with grating couplers in different locations 505; photonic fibers can be placed in lithographically defined V grooves on the cap in different x and y locations 510. The photonic chip grating couplers are offset in various directions and their respective fibers are also offset. The polished 45° angle, alignment, and bonding still apply in the same manner 515. This figure combines the pieces shown in FIGS. 2-4 for offset fibers.

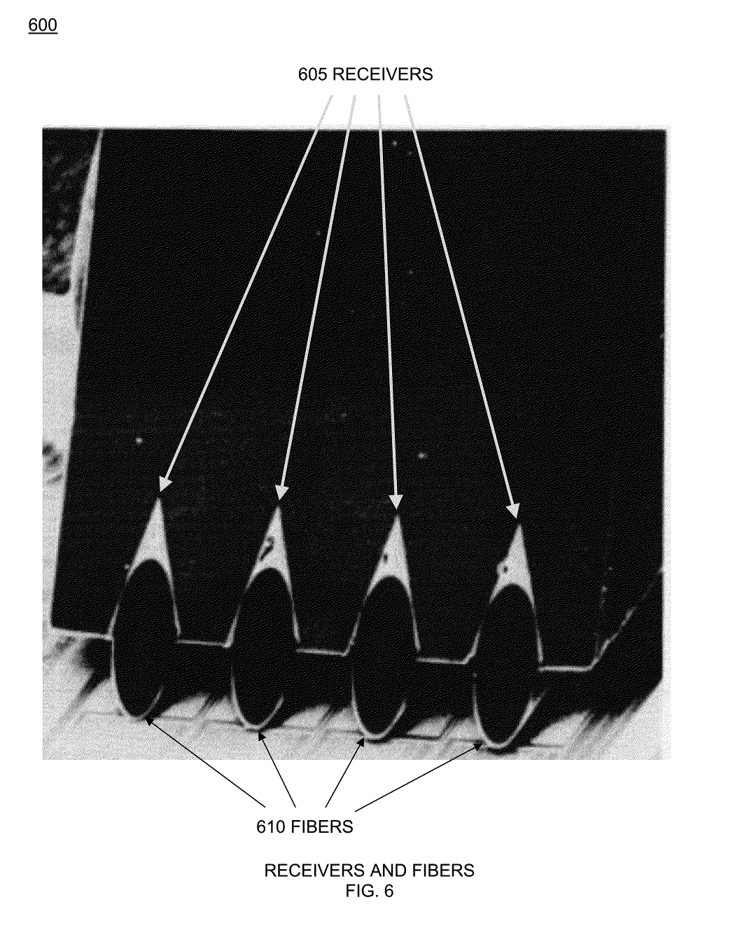

FIG. 6 is an image 600 showing the receivers 605 and fibers 610 in an embodiment of the invention.

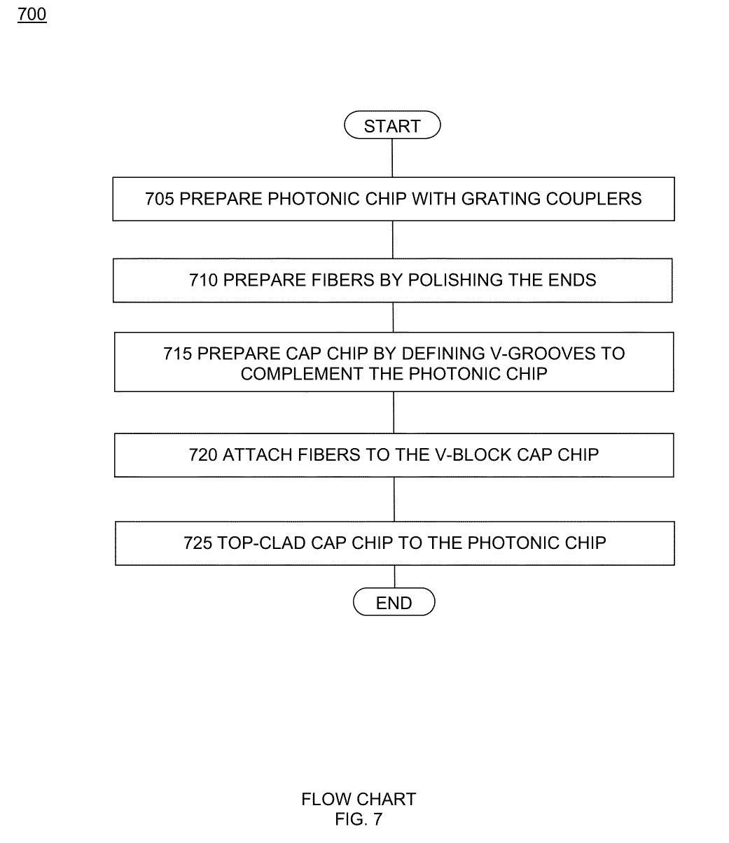

FIG. 7 is a flow chart 700 of a method to package and align top-coupling photonic chips using a holographic grating coupler and V-groove placement. Method steps comprise preparing the photonic chip with grating couplers 705; preparing the fibers by polishing the ends 710; preparing a cap chip by defining V-grooves to complement the photonic chip 715; attaching the fibers to the V-block cap chip 720; and top-cladding the cap chip to the photonic chip 725.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for bonding optical fibers to a photonic chip comprising the steps of:
preparing said photonic chip with at least one grating coupler;
preparing at least one said optical fiber by polishing an end;
preparing a cap chip by defining at least one V-groove;
attaching said at least one optical fiber to said V-block cap chip; and
top-cladding said V-block cap chip to said photonic chip.

2. The method of claim 1, wherein said fibers are polished at a 45° angle whereby said grating couplers on said photonic chip are illuminated.

3. The method of claim 1, wherein said fiber end is metalized to reflect an optical signal down from a horizontal plane to a vertical plane; and
said top cap chip is a photonic chip made of silicon.

4. The method of claim 1, wherein said at least one grating coupler vertically directs an optical signal from a surface of a die.

5. The method of claim 1, wherein said at least one grating coupler comprises a plurality of offset couplers.

6. The method of claim 3 wherein said at least one optical fiber is embedded so as to align said metalized end with said grating couplers on said photonic chip.

7. The method of claim 5, wherein z-axis alignment is controlled by said cladding.

8. The method of claim 1, wherein input light from said at least one optical fiber projects onto any light detector.

9. The method of claim 1, wherein said photonic chip allows for simultaneous reading of many different fiber sources.

10. A top-coupling photonic chip device comprising:
a photonic chip comprising at least one grating coupler;
a top cap chip comprising at least one V-groove; and
at least one optical fiber embedded in said at least one V-groove, and aligned with said at least one grating coupler.

11. The device of claim 10, wherein said at least one V-groove controls x- and y-axes alignment of said at least one optical fiber.

12. The device of claim 10, wherein said top cap chip is a photonic chip made of silicon.

13. The device of claim 10, wherein said at least one grating coupler vertically directs an optical signal from a surface of a die.

14. The device of claim 13, wherein said at least one grating coupler comprises at least one holographic grating coupler.

15. The device of claim 10 wherein at least one target area on said photonic chip is less than a square micron.

16. The device of claim 12, wherein said at least one V-groove is etched in said silicon.

17. The device of claim 10, wherein at least one grating coupler comprises a plurality of offset couplers.

18. The device of claim 10, wherein said device is an area detector.

19. The system of claim 18, wherein said device is a CMOS imager used to input light from an optical fiber onto any light detector.

20. A system for moving optical signals to and from photonic chips comprising:
a photonic chip comprising a plurality of holographic grating couplers;
a cap chip comprising a plurality of V-grooves;
a plurality of optical fibers, each embedded in a V-groove of said plurality of V-grooves, whereby each of said plurality of holographic grating couplers is aligned with one of said plurality of optical fibers;
said system inputting light from said plurality of optical fibers onto detectors of different light wavelengths; and
wherein at least one target area on said photonic chip is less than a square micron, and whereby high accuracy necessary for targeting areas less than a square micron is achieved.
